(19) United States
(12) Patent Application Publication
(10) Pub. No.: US 2020/0299050 A1
(43) Pub. Date: Sep. 24, 2020

(54) SALAD INGREDIENTS STORAGE ASSEMBLY

(71) Applicant: Brenda Hartke, Burnsville, MN (US)

(72) Inventor: Brenda Hartke, Burnsville, MN (US)

(21) Appl. No.: 16/360,084

(22) Filed: Mar. 21, 2019

(51) Int. Cl. B65D 81/32; B65D 51/28; B65D 51/16; B65D 43/02; A23L 27/60; A23L 19/00

(52) U.S. Cl. CPC B65D 81/3216; B65D 51/2807; B65D 51/1683; A23V 2002/00; A23L 27/60; A23L 19/00; B65D 43/0214

(57) ABSTRACT

A salad ingredients storage assembly for storing all of the ingredients to make a salad includes a tray for containing chopped lettuce or other vegetable base for a salad. A lid is removably positionable on the tray to close the tray. The lid forms a fluid impermeable seal with the tray to enhance freshness of the chopped lettuce of other vegetable base. A bin has a plurality of storage compartments being integrated therein and the bin is positionable on the lid when the lid is positioned on the tray. A plurality of containers is provided and each of the containers contains a respective one of a plurality of salad toppings. Each of the containers is removably stored in the bin for storing the plurality of salad toppings with the chopped lettuce or other vegetable base in the tray.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to storage devices and more particularly pertains to a new storage device for storing all of the ingredients to make a salad.

### BRIEF SUMMARY OF THE INVENTION

An embodiment of the disclosure meets the needs presented above by generally comprising a tray for containing chopped lettuce or other vegetable base for a salad. A lid is removably positionable on the tray to close the tray. The lid forms a fluid impermeable seal with the tray to enhance freshness of the chopped lettuce of other vegetable base. A bin has a plurality of storage compartments being integrated therein and the bin is positionable on the lid when the lid is positioned on the tray. A plurality of containers is provided and each of the containers contains a respective one of a plurality of salad toppings. Each of the containers is removably stored in the bin for storing the plurality of salad toppings with the chopped lettuce or other vegetable base in the tray.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a salad ingredients storage assembly according to an embodiment of the disclosure.

FIG. 2 is a top view of a tray, a lid and a bin of an embodiment of the disclosure.

FIG. 3 is a right side view of an embodiment of the disclosure.

FIG. 4 is a front view of an embodiment of the disclosure.

FIG. 5 is an exploded perspective view of an embodiment of the disclosure.

### DETAILED DESCRIPTION OF THE INVENTION

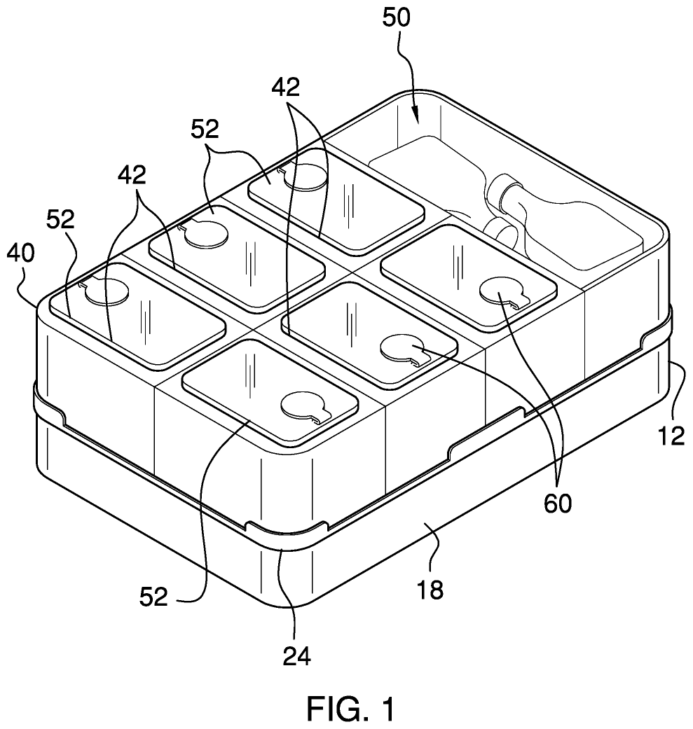

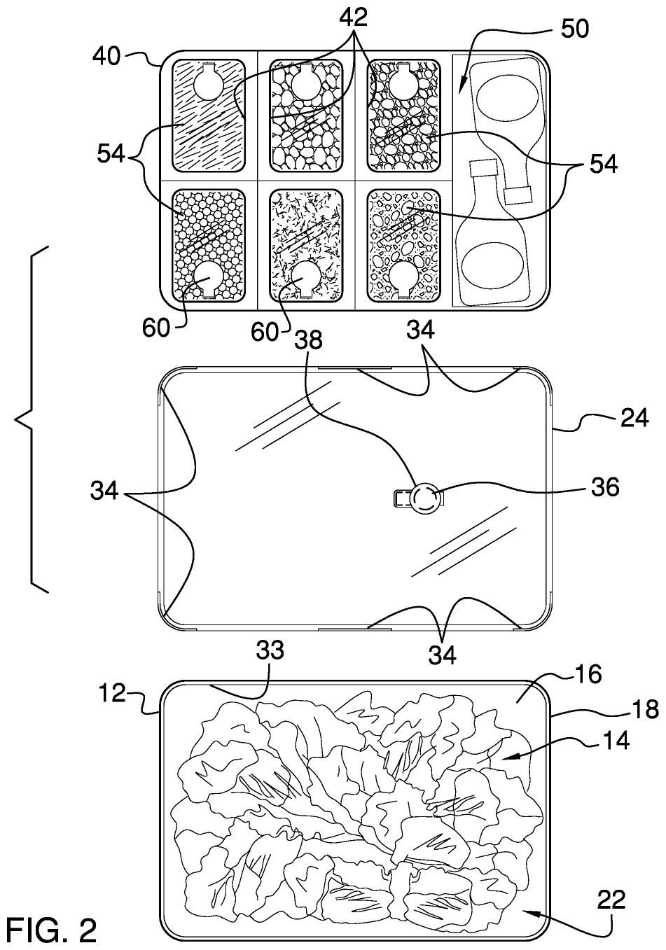

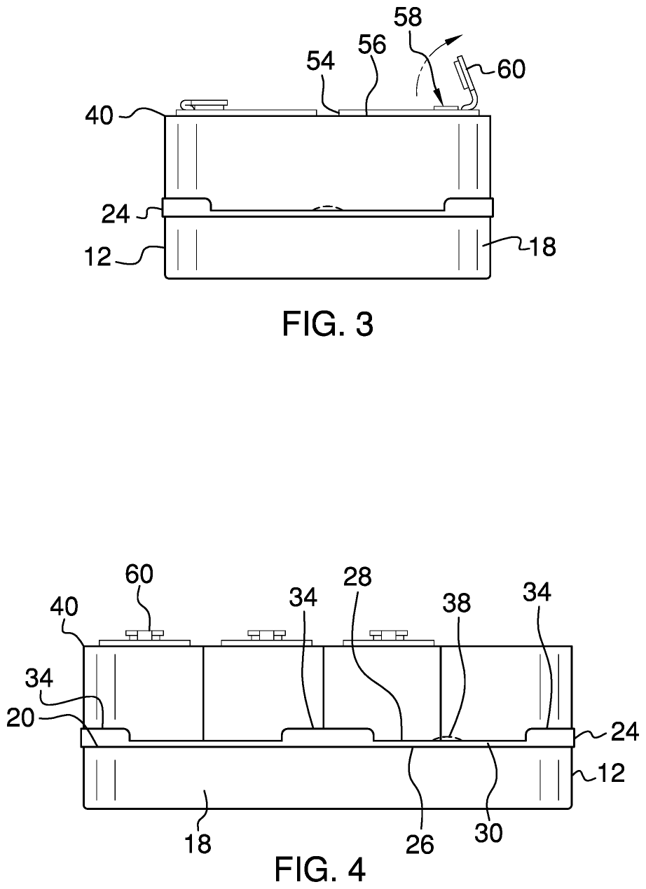

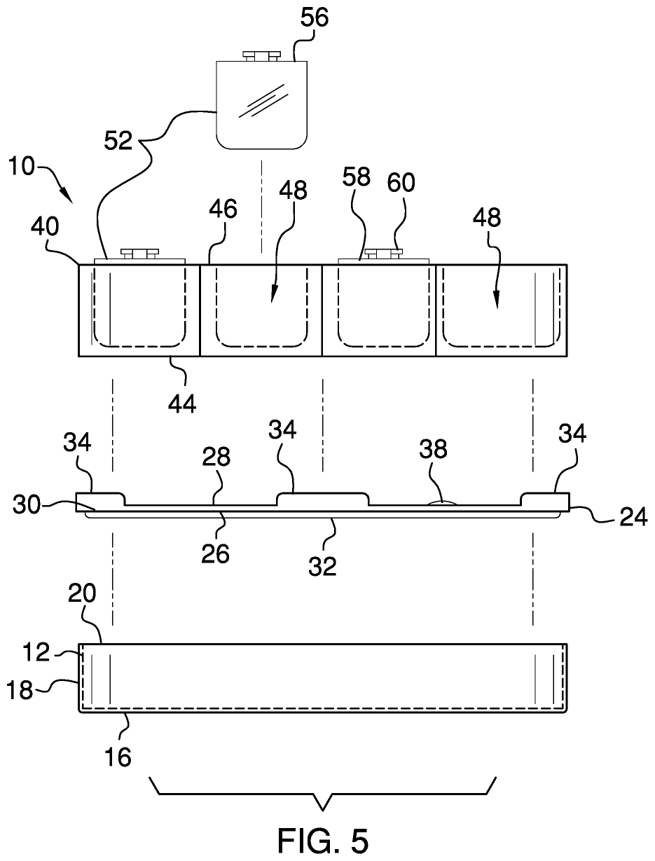

With reference now to the drawings, and in particular to FIGS. 1 through 5 thereof, a new storage device embodying the principles and concepts of an embodiment of the disclosure and generally designated by the reference numeral 10 will be described.

As best illustrated in FIGS. 1 through 5, the salad ingredients storage assembly 10 generally comprises a tray 12 for containing chopped lettuce 14 or other vegetable base for a salad. The tray 12 has a bottom wall 16 and a perimeter wall 18 extending upwardly therefrom. Additionally, the perimeter wall 18 has a distal edge 20 with respect to the bottom wall 16 defining an opening 22 into the tray 12. A lid 24 is removably positionable on the tray 12 to close the tray 12. The lid 24 forms a fluid impermeable seal with the tray 12 to enhance freshness of the chopped lettuce 14 of other vegetable base.

The lid 24 has a bottom surface 26, a top surface 28 and peripheral edge 30 extending therebetween and the bottom surface 26 has a prominence 32 extending downwardly therefrom. The prominence 32 is spaced inwardly from the peripheral edge 30 of the lid 24. The bottom surface 26 rests on the distal edge 20 of the perimeter wall 18 of the tray 12 when the lid 24 is positioned on the tray 12 having the prominence 32 engaging an inside surface 33 of the perimeter wall 18. Additionally, the prominence 32 forms a fluid impermeable seal with the perimeter wall 18 to enhance freshness of the chopped lettuce 14 or other vegetable base.

The top surface 28 has a plurality of lips 34 each extending upwardly therefrom. Each of the lips 34 is aligned with the peripheral edge 30 of the tray 12, and the lips 34 are spaced apart from each other and are distributed around the lid 24. The lid 24 has an air opening 36 extending through the top 28 and bottom 26 surfaces to pass air therethrough when the lid 24 is positioned on the tray 12. A cap 38 is coupled to the lid 24 and the cap 38 is positionable in the air opening 36 for closing the air opening 36. The cap 38 is removable from the air opening 36 for opening the air opening 36.

A bin 40 is included that has a plurality of storage compartments 42 each being integrated therein. The bin 40 is positionable on the lid 24 when the lid 24 is positioned on the tray 12. The bin 40 has a lower surface 44 and an upper surface 46, and the upper surface 46 has a plurality of wells 48 each extending toward the lower surface 44. Each of the wells 48 defines a respective one of the storage compartments 42. The lower surface 44 rests on the top surface 28 of the lid 24 when the bin 40 is positioned in the lid 24. Additionally, each of the lips 34 on the lid 24 inhibits the bin 40 for sliding off of the lid 24. The plurality of wells 48 includes a condiment well 50 for storing bottles of salad dressing or the like.

A plurality of containers 52 is provided and each of the containers 52 contains a respective one of a plurality of salad toppings 54. Each of the containers 52 is removably stored in the bin 40 for storing the plurality of salad toppings 54 with the chopped lettuce 14 or other vegetable base in the tray 12. Each of the containers 52 has a top wall 56 and the top wall 56 of each of the containers 52 has a dispensing hole 58 extending into an interior of the containers 52. The dispensing hole 58 in each of the containers 52 facilitates the respective salad topping 54 to be poured outwardly from the containers 52. The salad toppings 54 may be any topping that is placed on a salad. A plurality of closures 60 is included and each of the closures 60 is coupled to the top wall 56 of a respective one of the containers 52. Each of the closures 60 engages the dispensing hole 58 in the respective container for closing the dispensing hole 58 in the respective container.

In use, the chopped lettuce 14 or other vegetable base is placed in the tray 12 and the lid 24 is positioned on the tray 12 to close the tray 12. The bin 40 is positioned on the lid 24 and each of the containers 52 is filled with the respective salad topping and each of the containers 52 is positioned in the respective well. In this way all of the various ingredients for making a salad can be stored together. A salad can be made by removing a selected amount of the chopped lettuce 14 or other vegetable base from the tray 12. Selected ones of the containers 52 are removed from the bin 40 and the salad topping in the selected containers 52 is poured onto the chopped lettuce 14 or other vegetable base. In this way a salad can be made without with the ingredients stored in the tray 12 and the bin 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A salad ingredients storage assembly being configured to store a variety of ingredient for making a salad, said assembly comprising:
a tray for containing chopped lettuce or other vegetable base for a salad;
a lid being removably positionable on said tray to close said tray, said lid forming a fluid impermeable seal with said tray wherein said tray is configured to enhance freshness of the chopped lettuce of other vegetable base;
a bin having a plurality of storage compartments each being integrated therein, said bin being positionable on said lid when said lid is positioned on said tray; and
a plurality of containers, each of said containers containing a respective one of a plurality of salad toppings, each of said containers being removably stored in said bin wherein said bin is configured to store the plurality of salad toppings with the chopped lettuce or other vegetable base in said tray.

2. The assembly according to claim 1, wherein:
said tray has a bottom wall and a perimeter wall extending upwardly therefrom, said perimeter wall having a distal edge with respect to said bottom wall defining an opening into said tray; and
said lid has a bottom surface, a top surface and peripheral edge extending therebetween, said bottom surface having a prominence extending downwardly therefrom, said prominence being spaced inwardly from said peripheral edge of said lid, said bottom surface resting on said distal edge of said perimeter wall of said tray when said lid is positioned on said tray having said prominence engaging an inside surface of said perimeter wall, said prominence forming a fluid impermeable seal with said perimeter wall wherein said lid is configured to enhance freshness of the chopped lettuce or other vegetable base.

3. The assembly according to claim 2, wherein:
said top surface has a plurality of lips each extending upwardly therefrom, each of said lips being aligned with said peripheral edge of said tray, said lips being spaced apart from each other and being distributed around said lid; and
said lid having an air opening extending through said top and bottom surfaces wherein said air opening is configure to pass air therethrough when said lid is positioned on said tray.

4. The assembly according to claim 3, further comprising a cap being coupled to said lid, said cap being positionable in said air opening for closing said air opening, said cap being removable from said air opening for opening said air opening.

5. The assembly according to claim 3, wherein said bin has a lower surface and an upper surface, said upper surface having a plurality of wells each extending toward said lower surface, said lower surface resting on said top surface of said lid when said bin is positioned in said lid.

6. The assembly according to claim 1, wherein:
each of said containers has a top wall, said top wall of each of said containers having a dispensing hole extending into an interior of said containers wherein said dispensing hole in each of said containers is configured to have the respective salad topping poured outwardly therefrom; and
said assembly includes a plurality of closures, each of said closures being coupled to said top wall of a respective one of said containers, each of said closures engaging said dispensing hole in said respective container for closing said dispensing hole in said respective container.

7. A salad ingredients storage assembly being configured to store a variety of ingredient for making a salad, said assembly comprising:
a tray for containing chopped lettuce or other vegetable base for a salad, said tray having a bottom wall and a perimeter wall extending upwardly therefrom, said perimeter wall having a distal edge with respect to said bottom wall defining an opening into said tray;
a lid being removably positionable on said tray to close said tray, said lid forming a fluid impermeable seal with said tray wherein said tray is configured to enhance freshness of the chopped lettuce of other vegetable base, said lid having a bottom surface, a top surface and peripheral edge extending therebetween, said bottom surface having a prominence extending downwardly therefrom, said prominence being spaced inwardly from said peripheral edge of said lid, said bottom surface resting on said distal edge of said perimeter wall of said tray when said lid is positioned on said tray having said prominence engaging an inside surface of said perimeter wall, said prominence forming a fluid impermeable seal with said perimeter wall wherein said lid is configured to enhance freshness of the chopped lettuce or other vegetable base, said top surface having a plurality of lips each extending upwardly therefrom, each of said lips being aligned with said peripheral edge of said tray, said lips being spaced apart from each other and being distributed around said lid, said lid having an air opening extending through said top and bottom surfaces wherein said air opening is configure to pass air therethrough when said lid is positioned on said tray;
a cap being coupled to said lid, said cap being positionable in said air opening for closing said air opening, said cap being removable from said air opening for opening said air opening;
a bin having a plurality of storage compartments each being integrated therein, said bin being positionable on said lid when said lid is positioned on said tray, said bin having a lower surface and an upper surface, said upper surface having a plurality of wells each extending toward said lower surface, said lower surface resting on said top surface of said lid when said bin is positioned in said lid;
a plurality of containers, each of said containers containing a respective one of a plurality of salad toppings, each of said containers being removably stored in said bin wherein said bin is configured to store the plurality of salad toppings with the chopped lettuce or other vegetable base in said tray, each of said containers having a top wall, said top wall of each of said containers having a dispensing hole extending into an interior of said containers wherein said dispensing hole in each of said containers is configured to have the respective salad topping poured outwardly therefrom; and
a plurality of closures, each of said closures being coupled to said top wall of a respective one of said containers, each of said closures engaging said dispensing hole in said respective container for closing said dispensing hole in said respective container.
